(19) United States
(12) Patent Application Publication
(10) Pub. No.: US 2003/0047703 A1
(43) Pub. Date: Mar. 13, 2003

(54) Throttle valve apparatus for controlling fluid flow

(76) Inventor: Mark Patterson, Plano, TX (US)

Correspondence Address: Slater & Matsil, L.L.P., Suite 1000, 17950 Preston Rd., Dallas, TX, 75252-5793, US

(21) Appl. No.: 10/238,254

(22) Filed: Sep. 10, 2002

Related U.S. Application Data
(60) Provisional application No. 60/322,251, filed on Sep. 10, 2001.

(51) Int. Cl. F02D 9/08

(52) U.S. Cl. 251/301; 123/337; 251/308

(57) ABSTRACT

A throttle valve apparatus for controlling fluid flow includes a first shaft, a first throttle blade, a second shaft, and a second throttle blade. The first shaft extends along a first axis. The first axis extends across an interior portion of a throttle body and the first shaft is pivotably supported by the throttle body. The first blade includes a first pivot end and a first free end. The first blade is fixed to the first shaft at the first pivot end. The second shaft extends along a second axis. The second axis also extends across the interior portion of the throttle body and the second shaft is pivotably supported by the throttle body. The second blade includes a second pivot end and a second free end. The second blade is fixed to the second shaft at the second pivot end. The first and second axis may be aligned.

### CROSS-REFERENCE TO RELATED APPLICATION

This application claims the priority benefit of commonly owned U.S. Provisional Patent Application having Serial No. 60/322,251 entitled THROTTLE VALVE APPARATUS AND METHOD FOR CONTROLLING FLUID FLOW filed on Sep. 10, 2001, which is hereby incorporated by reference.

### TECHNICAL FIELD

The present invention relates to throttle valves for controlling fluid flow. In one aspect, it relates to a throttle valve apparatus for use on an internal combustion engine.

### BACKGROUND

A conventional throttle valve apparatus used on vehicle engine system, for example, often incorporates a butterfly valve with a single throttle blade that pivots about a single axis extending across the center of the throttle blade. FIGS. 1-4 show an example of a conventional throttle valve apparatus 10 having a single throttle blade 11. FIG. 1 shows a perspective view of a conventional throttle valve apparatus 10 incorporating a single throttle blade 11. FIG. 2 shows a sectional side view of the throttle valve apparatus 10 of FIG. 1 with the blade 11 in a closed position. FIGS. 3 and 4 show the throttle blade 11 of FIG. 2 in half-open and full-open positions, respectively. When a conventional throttle blade 11 is only partially opened (i.e., between fully closed and fully open), as shown in FIG. 3 for example, the throttle blade 11 causes a high pressure on one side of the blade and a low pressure on the other side. Such pressure difference causes turbulence. Also when a conventional throttle blade 11 is only partially opened, more air flows to one side of the throttle valve apparatus 10 than to the other side. This restricts the volumetric flow rate through the throttle body 12. Hence, there is a need for an improved throttle blade design that addresses these issues.

### BRIEF SUMMARY OF THE INVENTION

The problems and needs outlined above are addressed by embodiments of the present invention. In accordance with one aspect of the present invention, a throttle valve apparatus for controlling fluid flow is provided. The throttle valve apparatus includes a first shaft member, a first throttle blade, a second shaft member, and a second throttle blade. The first shaft member extends along a first axis. The first axis extends across an interior portion of a throttle body and the first shaft member is pivotably supported by the throttle body. The first throttle blade has a first pivot end and a first free end. The first throttle blade is fixed to the first shaft member at the first pivot end such that the first blade can pivot about the first axis when the first shaft member is pivoted about the first axis. The second shaft member extends along a second axis. The second axis extends across the interior portion of the throttle body and the second shaft member is pivotably supported by the throttle body. The second throttle blade has a second pivot end and a second free end. The second throttle blade is fixed to the second shaft member at the second pivot end such that the second blade can pivot about the second axis when the second shaft member is pivoted about the second axis. The first free end moves relative to the second free end when the first shaft member and the second shaft member move relative to each other.

The first axis may be substantially aligned with the second axis. The first and second shaft members may be hollow or solid. A central shaft member may extend along the first and second axis, and the central shaft member may extend through the first and second members. A spring may be biased between a first actuator and a second actuator, where the first actuator is directly or indirectly coupled to the first shaft member and the second actuator is directly or indirectly coupled to the second shaft member. The second actuator and the second shaft member may be fixed relative to the central shaft member. The second shaft member may be coupled to the second actuator via the central shaft member. The first actuator may be fixed directly to the first shaft member. The first axis may be adjacent and substantially parallel with the second axis, such that the first shaft member is adjacent and substantially parallel with the second shaft member. The apparatus may be configured so that the first free end of the first blade can move toward the second free end of the second blade as the blades pivot in opposite rotational directions relative to each other. The blades may be capable of pivoting independently of each other. The actuators may be levers, gears, and/or having gear portions. The movement of the second actuator may coincide with movement of the first actuator using gears or gear portions. The throttle valve apparatus may further include a fluid flow deflector located upstream of the first and second shafts and at least partially shielding the shafts from fluid flow through the throttle body in one direction.

In accordance with another aspect of the present invention, a throttle valve apparatus for controlling fluid flow is provided. This throttle valve apparatus includes a first hollow shaft member, a first throttle blade, a second hollow shaft member, a second throttle blade, and a central support shaft. The first hollow shaft member extends along a pivot axis. The pivot axis extends across an interior portion of a throttle body. The first throttle blade has a first pivot end and a first free end. The first throttle blade is fixed to the first shaft member at the first pivot end so that the first blade can pivot about the pivot axis when the first shaft member is pivoted about the pivot axis. The second hollow shaft member extends along the pivot axis. The second throttle blade has a second pivot end and a second free end. The second throttle blade is fixed to the second shaft member at the second pivot end so that the second blade can pivot about the pivot axis when the second shaft member is pivoted about the pivot axis. The first free end moves relative to the second free end when the first shaft member and the second shaft member move relative to each other. The central support shaft extends along the pivot axis across and through two sides of the throttle body. The central shaft extends through the first and second shaft members. The first and second shaft members are at least partially supported by the central shaft.

### BRIEF DESCRIPTION OF THE DRAWINGS

The above features of the present invention will be more clearly understood from consideration of the following descriptions in connection with accompanying drawings in which:

FIG. 1 is perspective view of a conventional single blade throttle body;

FIG. 2 is a sectional side view of the throttle body of FIG. 1 in a closed position;

FIG. 3 is a sectional side view of the throttle body of FIG. 1 in a half-open position;

FIG. 4 is a sectional side view of the throttle body of FIG. 1 in a full-open position;

FIG. 5A is a perspective view of a first embodiment of the present invention;

FIG. 5B is a sectional side view of the first embodiment in the closed position;

FIG. 5C is a top view of the first embodiment in the closed position;

FIG. 6A is a perspective view of the first embodiment with the throttle blade in a half-open position;

FIG. 6B is a sectional side view of the first embodiment in the half-open position;

FIG. 7A is a perspective view of the first embodiment with the throttle blade in a full-open position;

FIG. 7B is a sectional side view of the first embodiment in the full-open position;

FIG. 8A is a top view of a second embodiment of the present invention in a closed position;

FIG. 8B is a sectional side view of the second embodiment in the closed position;

FIG. 9 is a sectional side view of the second embodiment in a half-open position;

FIG. 10 is a sectional side view of the second embodiment in a full-open position;

FIGS. 11A-11D are top views of third, fourth, fifth, and sixth embodiments of the present invention, respectively, each in a closed position;

FIGS. 12A and 12B are sectional side views of seventh and eighth embodiments of the present invention, respectively;

FIG. 13 shows a top view of a ninth embodiment of the present invention;

FIG. 14 shows a perspective view of the blades of the ninth embodiment;

FIG. 15 is a plot showing a performance comparison between a conventional throttle body and a throttle body in accordance with the ninth embodiment;

FIG. 16 is a top view of a tenth embodiment of the present invention;

FIG. 17 is a top view of one of the blades of the tenth embodiment;

FIG. 18 is a sectional view showing a portion of a intake port having a conventional throttle blade therein;

FIG. 19 is a sectional view showing the intake port of FIG. 18 incorporating an embodiment of the present invention;

FIG. 20 is a side view of an upper portion of an engine incorporating an embodiment of the present invention and having portions cut away for illustration;

FIG. 21 is a front view of the upper engine portion of FIG. 20;

FIG. 22 is a side view showing a portion of an intake manifold incorporating an embodiment of the present invention and having portions cut away for illustration;

FIG. 23 is the side view of FIG. 22 showing one of the throttle blades in a different position;

FIG. 24 is a side view of a throttle body to show a possible throttle linkage for use with an embodiment of the present invention;

FIG. 25 is a side view of a throttle body to show another possible throttle linkage for use with an embodiment of the present invention; and

FIGS. 26A-26G each shows a cross-section view of a throttle blade tip.

### DETAILED DESCRIPTION OF PREFERRED EMBODIMENTS

Referring now to the drawings, wherein like reference numbers are used herein to designate like elements throughout the various views, preferred embodiments of the present invention are illustrated and described. As will be understood by one of ordinary skill in the art, the figures are not necessarily drawn to scale, and in some instances the drawings have been exaggerated and/or simplified in places for illustrative purposes only. One of ordinary skill in the art will appreciate the many applications and variations of the present invention in light of the following description for preferred embodiments of the present invention. The preferred embodiments discussed herein are just some illustrative examples of the present invention and do not limit the scope of the invention to the preferred embodiments described.

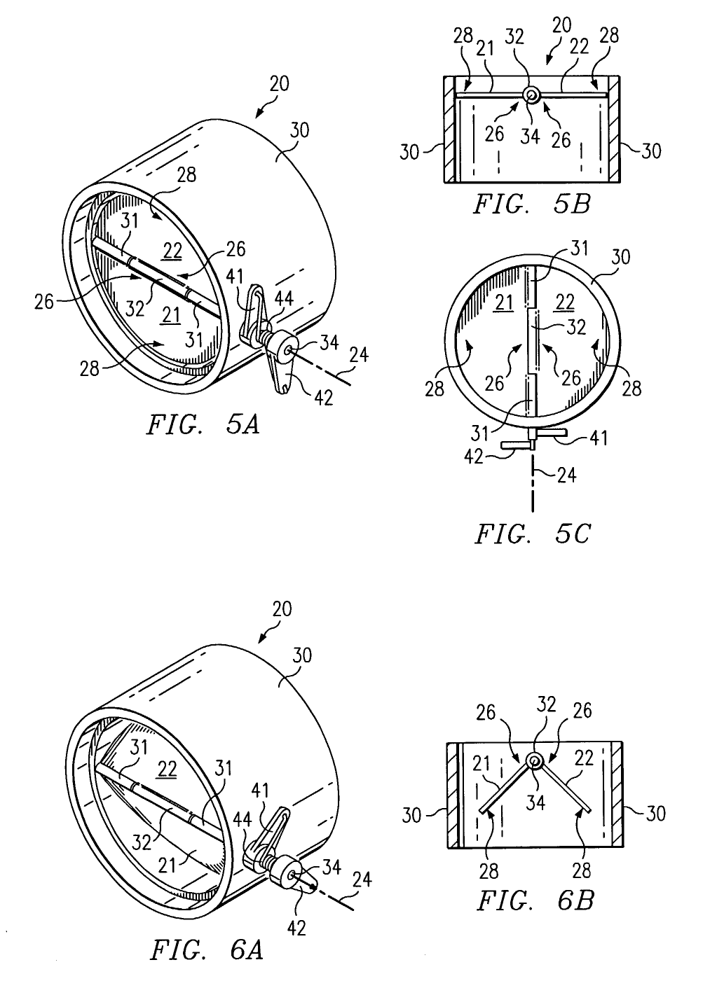

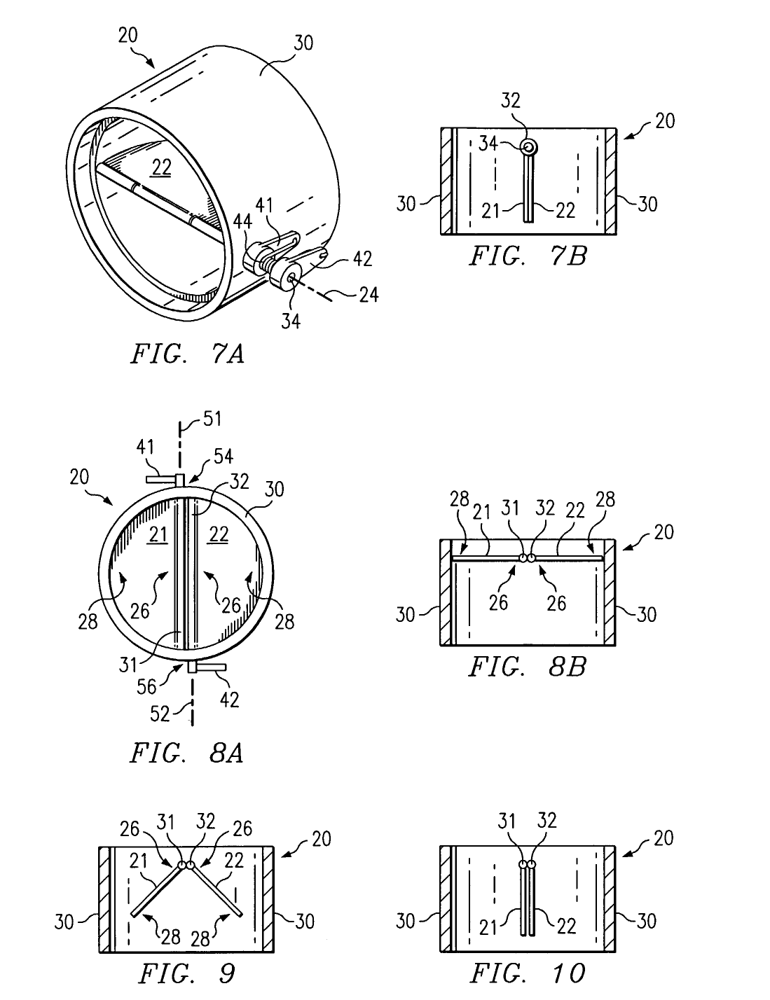

FIGS. 5A-7B show a throttle valve apparatus 20 in accordance with a first embodiment of the present invention. FIG. 5A is a perspective view of the throttle valve apparatus 20 with the throttle blades 21, 22 in a closed position. FIG. 5B is a sectional side view of the throttle valve apparatus 20 in the closed configuration. And, FIG. 5C is a top view of the throttle valve apparatus 20 in the closed configuration. FIGS. 6A and 6B show a perspective view and a sectional side view of the first embodiment, respectively, with the throttle blades 21, 22 in a half-open position. FIGS. 7A and 7B show a perspective view and a sectional side view of the first embodiment, respectively, with the throttle blades 21, 22 in a fill-open position.

The throttle valve apparatus 20 of the first embodiment has two throttle blades 21, 22 that pivot about the same pivot axis 24. Each throttle blade 21, 22 has a pivot end 26 and a free end 28. Because the throttle body 30 in the first embodiment has a circular cross-section shape, each throttle blade 21, 22 has a half-circle shape. The pivot end 26 is generally straight and the free end 28 has a curved contour corresponding with the interior contour of the throttle body 30. Each pivot end 26 is fixedly attached to a hollow shaft member 31, 32. The first shaft member 31 for the first blade 21 has two parts. The second shaft member 32 for the second blade 22 fits between the two parts of the first shaft member 31. A central shaft member 34 extends along the pivot axis 24 and through the first and second shaft members 31, 32 in a coaxial manner. The first shaft member 31 extends through a sidewall of the throttle body 30 at the lever end of the pivot axis 24. A first lever 41 is fixedly attached to the first shaft member 31. The second shaft member 32 is fixedly attached to the central shaft member 34. A second lever 42 is fixedly attached to the central shaft member 34. The central shaft member 34 extends through the sidewall of the throttle body 30 on both ends of the pivot axis 24. Hence, when the second lever 42 is pivoted about the pivot axis 24, the second blade 22 moves along with the second lever 42 and pivots about the pivot axis 24. When the first lever 41 is pivoted about the pivot axis 24, the first blade 21 moves along with the first lever 41 and pivots about the pivot axis 24. The assembly of the first lever 41, the first shaft member 31, and the first blade 21 can move independently and relative to the assembly of the second lever 42, the central shaft member 34, the second shaft member 32, and the second blade 22. As shown in FIGS. 5A, 6A, and 7A, a spring 44 is coupled to the first and second levers 41, 42. The spring 44 is biased between the first and second levers 41, 42 such that the first and second levers 41, 42 are biased toward a closed position.

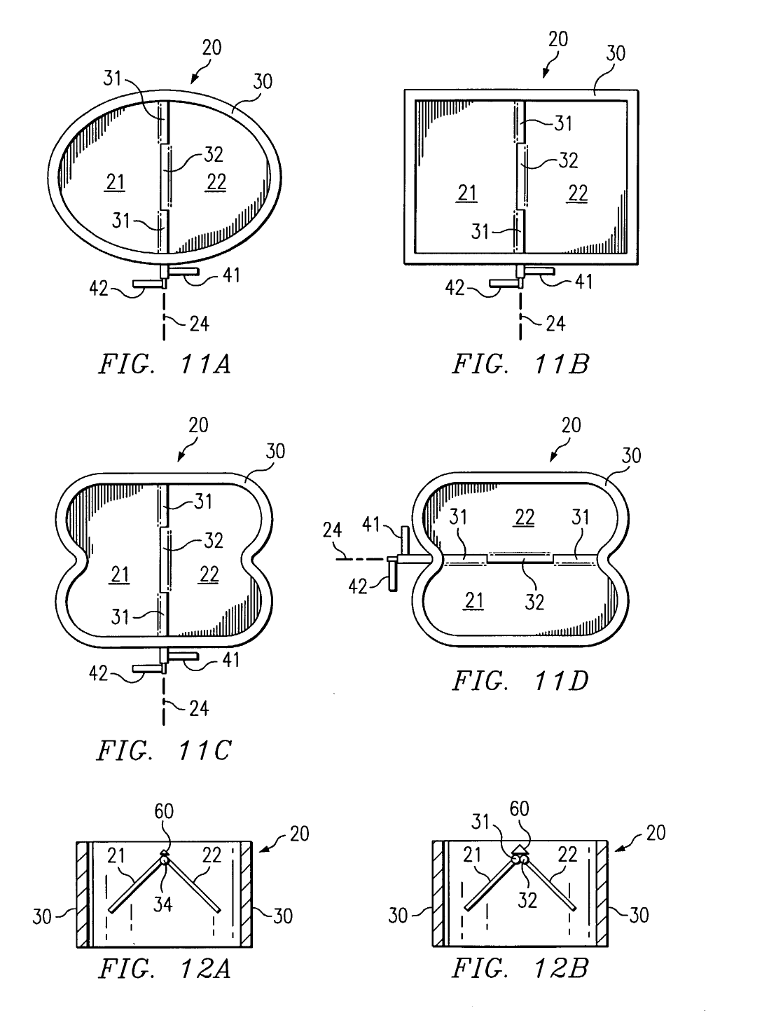

FIGS. 8A-10 show a throttle valve apparatus 20 in accordance with a second embodiment of the present invention. FIG. 8A is a top view of the throttle valve apparatus 20 with the blades 21, 22 in a closed position. FIG. 8B is a sectional side view of the throttle valve apparatus 20 of FIG. 8A. FIGS. 9 and 10 are sectional side views showing the throttle valve apparatus 20 of the second embodiment with the blades 21, 22 in half-open and full-open positions, respectively. In the second embodiment, each throttle blade 21, 22 pivots about its own axis 51, 52. As in the first embodiment, each blade 21, 22 is half-circle shaped because the throttle body 30 has a circular cross-section shape. The first blade 21 is fixedly attached to the first shaft member 31. The first shaft member 31 extends along a first pivot axis 51. One end of the first shaft member 31 extends through the sidewall of the throttle body 30 at a first side 54 of the throttle body 30, and a first actuator 41, which is a lever in this case, is fixedly attached to the first shaft 31 at this end, as shown in FIG. 8A. Another end of the first shaft member 31 extends into, but not through, the sidewall of the throttle body 30 at a second side 56 of the throttle body 30. Similarly, the second blade 22 is fixedly attached to the second shaft member 32. The second shaft member 32 extends along a second pivot axis 52. One end of the second shaft member 32 extends through the sidewall of the throttle body 30 at the second side 56 of the throttle body 30, and a second actuator 42, which is also a lever in this case, is fixedly attached to the second shaft member 32 at this end, as shown in FIG. 8A. Another end of the second shaft member 32 extends into, but not through, the sidewall of the throttle body 30 at the first side 54 of the throttle body 30. Thus, the first pivot axis 51 is adjacent and substantially parallel with the second pivot axis 52, and likewise, the first shaft member 31 is adjacent and substantially parallel with the second shaft member 32. In another embodiment of the present invention (see FIG. 16 below), the second embodiment may be varied so that the first and second actuators 41, 42 are on the same side of the throttle body 30, rather than on opposite sides.

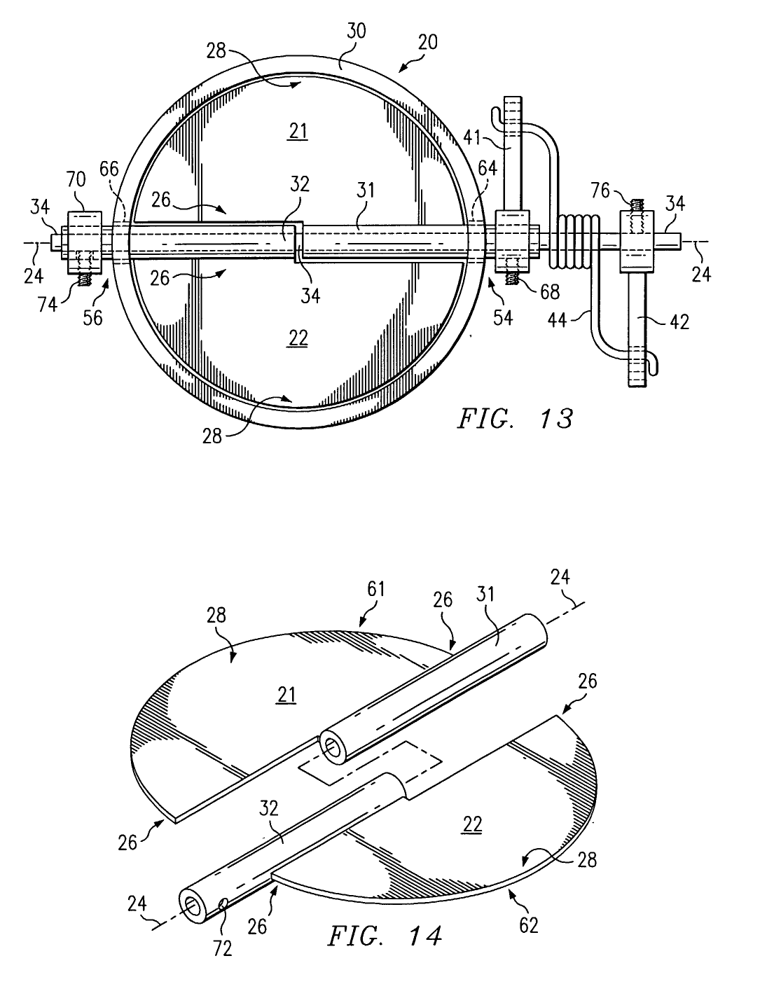

Although the throttle bodies 30 shown in the first and second embodiments have circular cross-section shapes, many other shapes are possible. FIGS. 11A-11D are top views of throttle valve apparatuses 20 in accordance with third, fourth, fifth, and sixth embodiments of the present invention, respectively. These embodiments in FIGS. 11A-11D illustrate just a few throttle body cross-section shapes that may be used, as well as shapes of the blades 21, 22 for these embodiments to fit such throttle body shapes. Therefore with the benefit of this disclosure, it will be apparent to one of ordinary skill in the art that the throttle body cross-section shapes and the blade shapes may vary widely.

FIGS. 12A and 12B are sectional side views of throttle valve apparatuses 20 in accordance with seventh and eighth embodiments of the present invention, respectively. These embodiments have the addition of a fluid flow deflector 60 located upstream of the first and second shaft members 31, 32. The fluid flow deflector 60 at least partially shields the shaft members 31, 32, 34 from the fluid flow through the throttle body 30 in one direction. Such fluid flow deflector 60 may help improve the fluid flow through the throttle body 30 by acting as a splitter. Also, the fluid flow deflector 60 may help reduce fluid pressure exerted on the shafts 31, 32, 34 by shielding them from the fluid flow, which may be especially important if the fluid is a liquid. Also, if the fluid flow contains solid particles, the fluid flow deflector 60 may help prevent solid particles from collecting at the shafts. Such accumulation of solid particles may hinder or disrupt the pivotal movement of the shaft members when the blades are being actuated. Also, the fluid flow deflector 60 may prevent solid particles from colliding with the shaft members, which may damage or erode the shaft members. The fluid flow deflector 60 may be added to any of the embodiments of the present invention as an optional feature to provide the above-described advantages.

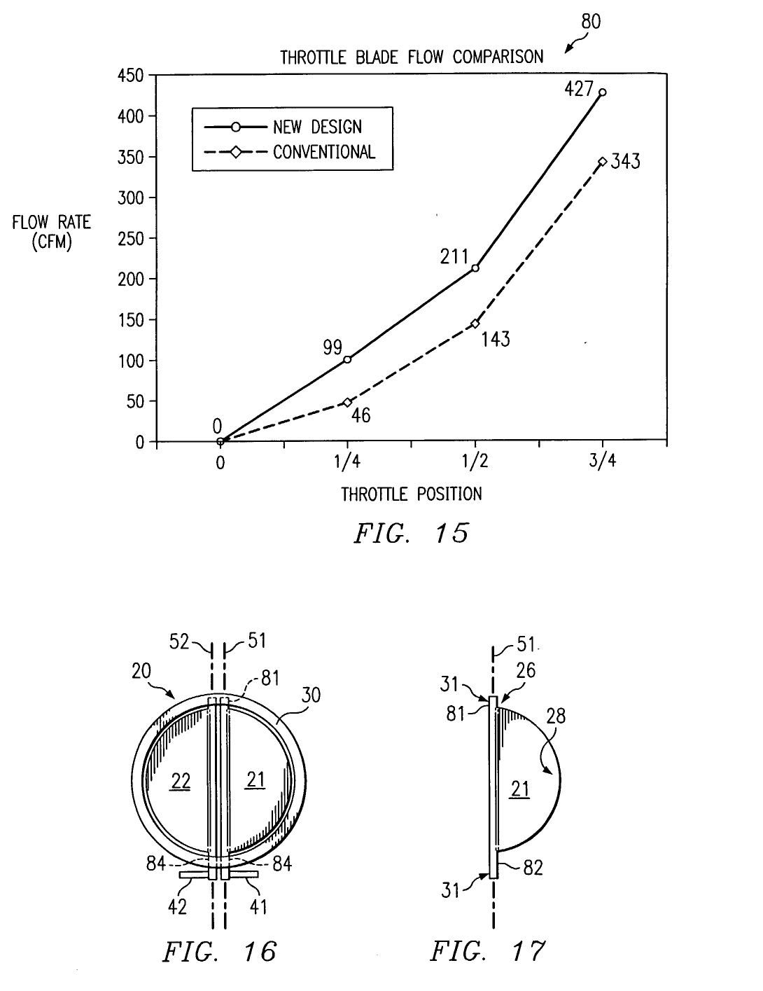

FIGS. 13-15 pertain to a ninth embodiment of the present invention. FIG. 13 is a top view of the ninth embodiment. FIG. 14 is a perspective view of the blades 21, 22 for the ninth embodiment. In the ninth embodiment, the first shaft member 31 and the first throttle valve blade 21 are integral parts of a single molded piece 61. Likewise, the second shaft member 32 and the second blade 22 are integral parts of another single molded piece 62. The shaft members 31, 32 are hollow. The first shaft member 31 fits through a first hole 64 formed through a sidewall of the throttle body 30 on a first side 54 of the throttle body 30. A first actuator 41 fits over the first shaft member 31 and is fixed relative to the first shaft member 31 by a first set screw 68. The first set screw 68 presses against the outside of the first shaft member 31 and may extend partially into the first shaft member 31. The second shaft member 32 fits through a second hole 66 formed through the sidewall of the throttle body 30 on a second side 56 of the throttle body 30. A central shaft member 34 extends along the pivot axis 24, through the throttle body 30, and through the first and second shafts 31, 32. Hence, the first and second shafts 31, 32 are coaxially aligned with the central shaft member 34 along the pivot axis 24.

A collar 70 fits over the second shaft member 32 outside of the throttle body 30. As shown in FIG. 14, a hole 72 is formed in the second shaft member 32 so that a second set screw 74 threadedly engaged within the collar 70 can extend through the second shaft member 32 and press against the central shaft member 34. Thus, the second set screw 74 and the collar 70 fix the second shaft member 32 to the central shaft member 34.

A second actuator 42 fits over the central shaft member 34 and is fixed to the central shaft member 34 by a third set screw 76. Hence, when the second actuator 42 is pivoted about the pivot axis 24, it actuates pivotal movement of the central shaft 34, which in turn actuates the pivotal movement of the second shaft member 32 and the second blade 22. Thus, the central shaft member 34 pivots within and relative to the first shaft member 31. A spring 44 is biased between the first and second actuators 41, 42, and the spring 44 biases the first and second blades 21, 22 toward a closed configuration. A pivot stop (not shown) may be needed to limit the pivotal movement of the actuators 41, 42 due to the spring bias.

FIG. 15 is a plot 80 showing the results of a test performed by the inventor. In this test, the throttle valve apparatus 20 of the ninth embodiment shown in FIG. 13 was compared to a conventional throttle valve apparatus design, as shown in FIGS. 1-4 as throttle valve apparatus 10. For the comparison test, the throttle bodies 30, 12 of the ninth embodiment and the conventional single-blade design were made from the same material (PVC pipe) and had the same diameters (3 inch diameter). Also, the throttle blades 11, 21, 22 of the ninth embodiment and the conventional single-blade design were made from the same material (brass). First the throttle valve apparatus 10 of the conventional single-blade design was tested on a flow bench at pressure of about 28 inches of water (about 1 psi). The volumetric flow rate through the conventional throttle valve apparatus 10 was measured at one-quarter-open, half-open (as shown in FIG. 3), and three-quarter-open positions for the throttle blade 11, which resulted in flow rate measurements of 46 cubic feet per minute (CFM), 143 CFM, and 343 CFM, respectively (see FIG. 15). Then, the throttle valve apparatus 20 of the ninth embodiment (see FIG. 13) was fastened to the flow bench in an identical manner and tested under identical conditions. At one-quarter-open, half-open, and three-quarter-open throttle blade positions, the volumetric flow rate measurements were 99 CFM, 211 CFM, and 427 CFM, respectively (see FIG. 15). Thus, the ninth embodiment of the present invention provided a 115% increase in volumetric flow rate at the one-quarter-open throttle position, a 47% increase in flow rate at the half-open throttle position, and a 24% increase in flow rate at the three-quarter-open throttle position.

FIGS. 16 and 17 show a tenth embodiment of the present invention. FIG. 16 is a top view of the throttle valve apparatus 20 of the tenth embodiment. FIG. 17 shows one of the throttle blades 21 of the tenth embodiment. As shown in FIG. 17, the first shaft member 31 is an integral part of the first blade 21 in the tenth embodiment. In this case, the first shaft member 21 has a first portion 81 that extends from one end of the first blade 21, and it has a second portion 82 that extends from another end of the first blade 21. As shown in FIG. 16, holes 84 are formed in a sidewall of the throttle body 30 to allow the second portions 82 of the first and second shaft members 31, 32 to extend through and outside of the throttle body 30 where the actuators 41, 42 are attached.

The next series of figures illustrate some possible uses of embodiments of the present invention. Although the throttle bodies 30 of FIGS. 1-13 were shown as separate members (i.e., not connected to anything) for purposes of illustration, the phrase “throttle body” is used herein to denote the structure that forms the fluid channel in which the throttle blades 21, 22 are placed within and by which the throttle blades 21, 22 are supported. Thus, a throttle body 30 may be an integral part of a port or manifold, or it may be a separate part, which may be fastened to another part or system during normal use.

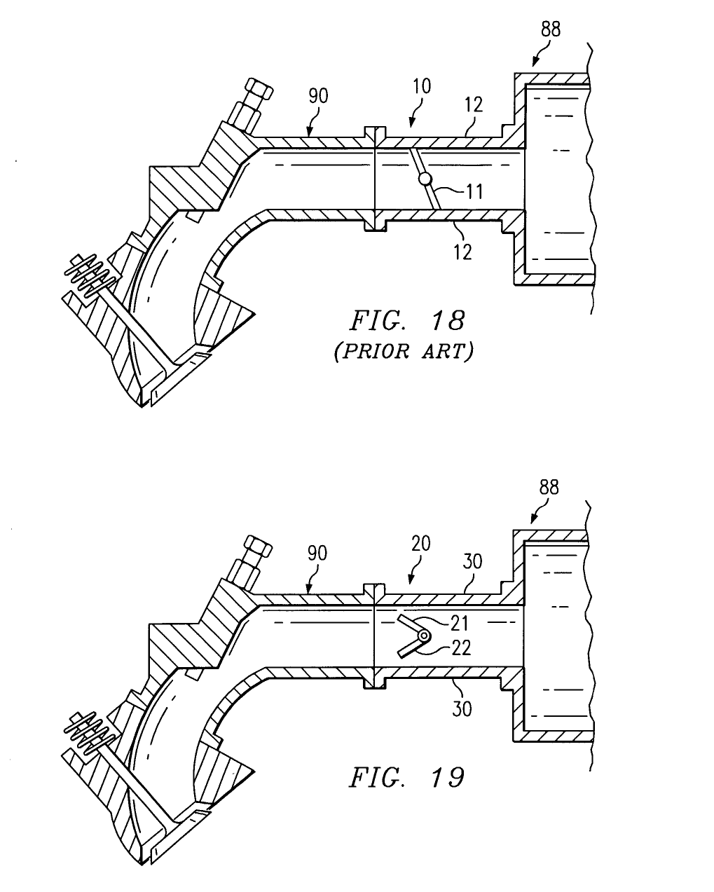

FIG. 18 is a sectional view a portion of an intake manifold 88 and an intake port 90 on an engine for a 1990 Lotus Esprit SE sports car. A conventional single-blade throttle blade 11 is used in this design. However, FIG. 19 illustrates how an embodiment of the present invention may be incorporated into this engine system in place of the conventional single-blade throttle valve 11. As shown in the inventor's testing discussed above (see FIG. 15), it is expected that with the incorporation of an embodiment of the present invention (as in FIG. 19), the intake port 90 will have a higher flowrate for most partially-open positions of the throttle blades 21, 22, which may increase the performance of the engine.

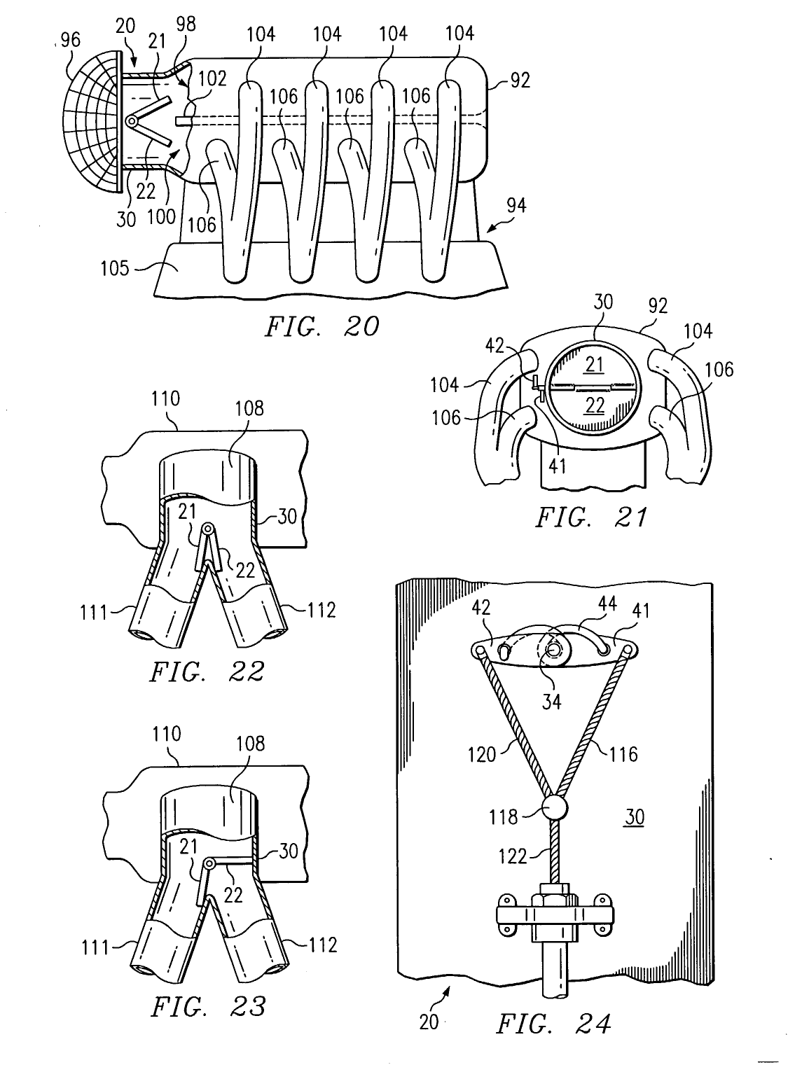

FIGS. 20 and 21 show an eleventh embodiment of the present invention. FIG. 20 is a side view showing an intake manifold 92 installed on an engine 94. FIG. 21 shows a front view of the intake manifold 92 with the air filter 96 removed for purposes of illustration. Without the air filter 96 installed, the throttle blades 21, 22 can be seen in FIG. 21. In FIG. 20, a portion of the intake manifold 92 is broken away to show a side view of the throttle blades 21, 22. The intake manifold 92 has an upper and lower plenum 98, 100 separated by a divider 102. A first set of intake ports 104 extend from the upper plenum 98 to the intake valve ports (not shown) of a head 105, which lead to the engine cylinders (not shown). A second set of intake ports 106 extend from the lower plenum 100 to the intake valve ports (not shown) of the head 105, where the first and second sets of intake ports 104, 106 merge together. In the eleventh embodiment, the first (or upper) throttle blade 21 controls and channels air flow into the upper plenum 98, and the second (or lower) throttle blade 22 controls and channels air flow into the lower plenum 100. The first and second throttle blades 21, 22 may be actuated together (i.e., linked together) or they may be actuated separately. Because the first and second throttle blades 21, 22 may be actuated separately, the air flow into the upper and lower plenums 98, 100 may be varied independently, depending on the programming of the fuel curves and depending on the application and needs (e.g., pulling power, increased horsepower, better low-end response, etc.). Thus, the eleventh embodiment provides many different possible options for tuning and fuel curve programming.

FIGS. 22 and 23 show a twelfth embodiment of the present invention. The throttle body 30 of the twelfth embodiment is an intake port 108 of an intake manifold 110 leading to an engine cylinder head (not shown). In FIGS. 22 and 23, a portion of the intake port 108 is broken away to the show the throttle blades 21, 22 therein. In FIG. 22, both throttle blades 21, 22 are in a full-open position allowing maximum air flow to both parts 111, 112 of the intake port 108. In FIG. 23, the second throttle blade 22 is in a closed position and the first throttle blade 21 is in a full-open position. Because the throttle blades 21, 22 may be actuated independently, the air flow may be directed to either or both parts 111, 112 of the intake port 108 at varying amounts. Thus, the twelfth embodiment also provides many tuning and fuel curve programming options.

The throttle blades 21, 22, the shaft members 31, 32, 34, and the actuators 41, 42 of an embodiment may be made from any of a variety of materials, including but not limited to: metal, plastic, wood, nylon, laminated composites, or any combination thereof, for example. The throttle blades 21, 22 may be permanently or removably attached to their corresponding shaft members 31, 32. A throttle blade may be fixed to a shaft member by an adhesive bond, by a weld, by a thermal bond, by a screw, or any combination thereof, for example. Also, a shaft member may be an integral part of a throttle blade (e.g., a single molded or cast piece).

The actuators 41, 42 for an embodiment may vary in size, shape, and type. An actuator may be a lever, a gear, or a partial gear, for example. The actuators may be linked together so that they move in unison, or they may be controlled separately by separate means. The actuators may be moved and controlled manually, mechanically by a linkage, electrically by a motor or solenoid, hydraulically by a hydraulic cylinder, or pneumatically by a vacuum, for example. FIG. 24 shows a way to pull both actuators 41, 42 at the same time and at about the same angle for each throttle blade 21, 22 throughout the range of blade movement. In FIG. 24, a first cable member 116 extends from the first actuator (lever 41) to a central connector 118. A second cable member 120 extends from the second actuator (lever 42) to the central connector 118. Hence, pulling the central connector 118 with a main cable 122 in turn pulls the first and second cable members 116, 120 also.

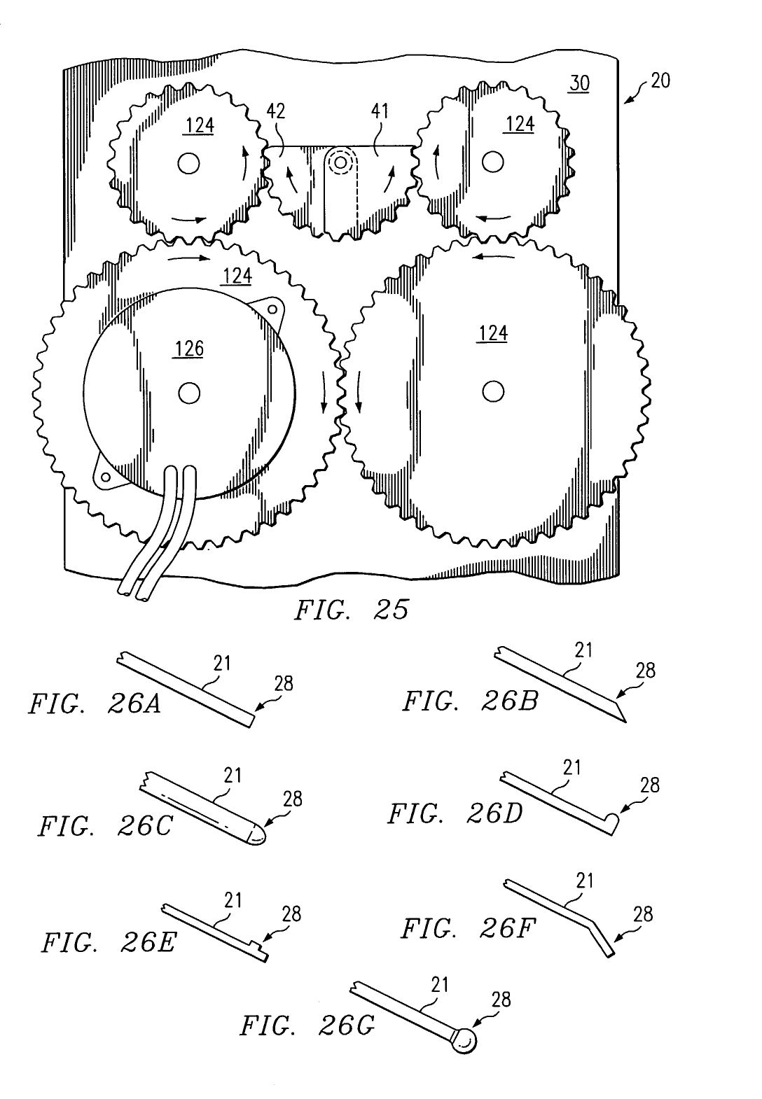

FIG. 25 shows another way to link together both actuators 41, 42 using gears 124. An electric motor 126 is coupled to one of the gears 124 to drive both actuators 41, 42 at the same time via the gears 124. In another embodiment (not shown), each actuator (and hence each blade) may be driven independently by a separate electric motor, for example, to provide more options in varying the flow rate or controlling the flow rate using an embodiment of the present invention.

The cross-section shape and thickness of a throttle blade 21 and/or 22 need not be flat and plate-like. In other words, the cross-section shape and thickness of a throttle blade may vary among embodiments. FIGS. 26A-26G each shows a cross-section view of a free end 28 of a first throttle blade 21 to illustrate some different possible blade tips (free ends 28) and blade shapes. With the benefit of this disclosure, one of ordinary skill in the art will realize many other different blade tips and shapes may be possible. The shape of the blade tip 28 effects the type of flow for the fluid after it passes over the blade 21 (e.g., turbulent, laminar, eddy swirls, etc.). Thus, the blade tip shape may be chosen to suit a desired flow characteristic for a given application.

Another application may use an embodiment of the present invention as a waste gate valve for a turbocharger system, for example. Although many of the applications and embodiments of the present invention discussed thus far have focused on engine applications, an embodiment of the present invention may have many other possible applications, including but not limited to: any machine with an internal combustion engine; steam turbines; gas turbines; jet engines; liquid plumbing; a manufacturing process machine having a portion for controlling fluid flow (e.g., steam flow, vapor flow, gas flow); and heating, ventilation, and air conditioning (HVAC) systems, for example. Motorized vehicle applications may include, but are not limited to: motorcycles, snowmobiles, cars, trucks, tractors, boats, jet skis, trains, airplanes, helicopters, tanks, or submarines, for example. The term “fluid,” as used herein, is used in its broadest sense, including: air, gas, liquid, suspended solid particles, vapor, steam, or any combination thereof.

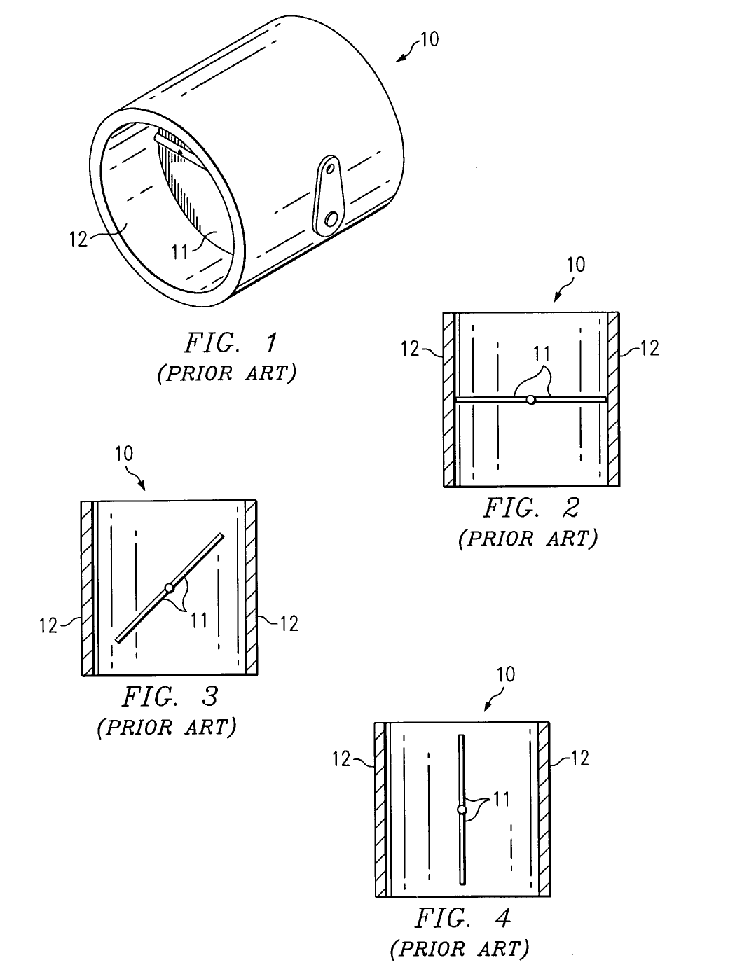

Another advantage of an embodiment of the present invention, in comparison to a conventional throttle valve apparatus, is that less space is required within the throttle body for an embodiment of the present invention. For example, compare the side views of the conventional throttle valve apparatus 10 shown in FIGS. 2-4 with the side views of the throttle valve apparatus 20 of the first embodiment shown in FIGS. 5B, 6B, and 7B. The conventional blade 11 requires twice the space in length within the throttle body 30 when fully opened (see FIG. 4), as compared to the throttle blades 21, 22 of the first embodiment in a full-open position (see FIG. 7B). This is also shown in FIG. 10 for the second embodiment. Such space savings may be vital to an engine layout design, for example. Also, in comparing these same figures, note in the full-open positions (see FIGS. 4, 7B, and 10) that the surface area that the fluid flow passes over while streaming past the blades 21, 22 of an embodiment of the present invention is roughly half that of the conventional design. That is, the exposed surface area of the blades 21, 22 (see FIGS. 7B and 10) is roughly half that of the conventional blade (see FIG. 4). Also, the length of the throttle body 30 required for an embodiment of the present invention (see FIGS. 7B and 10) is roughly half that of the conventional throttle body 12 (see FIG. 4). A reduction in the amount of surface area (over the blades and the sidewalls of the throttle body) that the fluid must flow will thus reduce the surface drag and flow restriction of the fluid flow.

It will be appreciated by those skilled in the art having the benefit of this disclosure that an embodiment of the present invention provides an improved throttle valve apparatus. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A throttle valve apparatus for controlling fluid flow, comprising:
a first shaft member extending along a first axis, wherein the first axis extends across an interior portion of a throttle body and the first shaft member being pivotably supported by the throttle body;
a first throttle blade includes a first pivot end and a first free end, the first throttle blade being fixed to the first shaft member at the first pivot end such that the first blade can pivot about the first axis when the first shaft member is pivoted about the first axis;
a second shaft member extending along a second axis, wherein the second axis extends across the interior portion of the throttle body and the second shaft member being pivotably supported by the throttle body; and
a second throttle blade includes a second pivot end and a second free end, the second throttle blade being fixed to the second shaft member at the second pivot end such that the second blade can pivot about the second axis when the second shaft member is pivoted about the second axis, wherein the first free end moves relative to the second free end when the first shaft member and the second shaft member move relative to each other.

2. The throttle valve apparatus of claim 1, wherein the first axis is substantially aligned with the second axis.

3. The throttle valve apparatus of claim 2, wherein the first and second shaft members are hollow, and further comprising:
a central shaft member extending along the first and second axis, the central shaft member extending through the first and second members.

4. The throttle valve apparatus of claim 3, further comprising a spring biased between a first actuator and a second actuator, the first actuator being coupled to the first shaft member and the second actuator being coupled to the second shaft member.

5. The throttle valve apparatus of claim 4, wherein the second actuator and the second shaft member are fixed relative to the central shaft member, the second shaft member is coupled to the second actuator via the central shaft member, and the first actuator is fixed directly to the first shaft member.

6. The throttle valve apparatus of claim 1, wherein the first axis is adjacent and substantially parallel with the second axis, and wherein the first shaft member is adjacent and substantially parallel with the second shaft member.

7. The throttle valve apparatus of claim 1, wherein the apparatus is configured such that the first free end of the first blade can move toward the second free end of the second blade as the blades pivot in opposite rotational directions relative to each other.

8. The throttle valve apparatus of claim 1, further comprising:
a first throttle actuator mechanically coupled to the first shaft member; and
a second throttle actuator mechanically coupled to the second shaft member.

9. The throttle valve apparatus of claim 8, wherein the blades are capable of pivoting independently of each other.

10. The throttle valve apparatus of claim 8, wherein the actuators are levers.

11. The throttle valve apparatus of claim 10, further comprising:
a first cable member;
a second cable member; and
a central connector, wherein the levers are linked together by the cable members, the first cable member extending from the first lever to the central connector, and the second cable member extending from the second lever to the central connector.

12. The throttle valve apparatus of claim 8, wherein each of the actuators has a gear portion.

13. The throttle valve apparatus of claim 12, wherein movement of the second actuator coincides with movement of the first actuator via the gear portions.

14. The throttle valve apparatus of claim 1, wherein the first shaft member and the first blade may be integral parts of a single piece.

15. The throttle valve apparatus of claim 1, wherein the first blade is permanently bonded to the first shaft member.

16. The throttle valve apparatus of claim 1, wherein the first blade is removably attached to the first shaft member.

17. The throttle valve apparatus of claim 1, further comprising a fluid flow deflector located upstream of the first and second shafts and at least partially shielding the shafts from fluid flow through the throttle body in one direction.

18. A motorized vehicle incorporating the throttle valve apparatus of claim 1.

19. A throttle valve apparatus for controlling fluid flow, comprising:
a first hollow shaft member extending along a pivot axis, wherein the pivot axis extends across an interior portion of a throttle body;
a first throttle blade includes a first pivot end and a first free end, the first throttle blade being fixed to the first shaft member at the first pivot end such that the first blade can pivot about the pivot axis when the first shaft member is pivoted about the pivot axis;
a second hollow shaft member extending along the pivot axis;
a second throttle blade includes a second pivot end and a second free end, the second throttle blade being fixed to the second shaft member at the second pivot end such that the second blade can pivot about the pivot axis when the second shaft member is pivoted about the pivot axis, wherein the first free end moves relative to the second free end when the first shaft member and the second shaft member move relative to each other; and
a central support shaft extending along the pivot axis across and through two sides of the throttle body, the central shaft extending through the first and second shaft members, and the first and second shaft members being at least partially supported by the central shaft.

20. A throttle valve apparatus for controlling fluid flow, comprising:
a first shaft member extending along a first axis, wherein the first axis extends across an interior portion of a throttle body and the first shaft member being pivotably supported by the throttle body;
a first throttle blade includes a first pivot end and a first free end, the first throttle blade being fixed to the first shaft member at the first pivot end such that the first blade can pivot about the first axis when the first shaft member is pivoted about the first axis;
a second shaft member extending along a second axis, wherein the second axis extends across the interior portion of the throttle body and the second shaft member being pivotably supported by the throttle body;
a second throttle blade includes a second pivot end and a second free end, the second throttle blade being fixed to the second shaft member at the second pivot end such that the second blade can pivot about the second axis when the second shaft member is pivoted about the second axis, wherein the first free end moves relative to the second free end when the first shaft member and the second shaft member move relative to each other;
a first throttle actuator mechanically coupled to the first shaft member;
a second throttle actuator mechanically coupled to the second shaft member,
wherein the blades are capable of pivoting independently of each other,
wherein the actuators are levers,
wherein the first axis is adjacent and substantially parallel with the second axis, and
wherein the first shaft member is adjacent and substantially parallel with the second shaft member;
a first cable member;
a second cable member;
a central connector, wherein the levers are linked together by the cable members, the first cable member extending from the first lever to the central connector, and the second cable member extending from the second lever to the central connector;
a spring biased between the first actuator and the second actuator,
wherein the apparatus is configured such that the first free end of the first blade moves toward the second free end of the second blade as the blades pivot in opposite rotational directions relative to each other when the central connector is pulled in a first direction to move the blades toward a full-open position, and
wherein the spring biases the blades toward a closed position; and
a fluid flow deflector located upstream of the first and second shafts and at least partially shielding the shafts from fluid flow through the throttle body in one direction.
